(19) United States
(12) Patent Application Publication
(10) Pub. No.: US 2004/0209770 A1
(43) Pub. Date: Oct. 21, 2004

(54) Catalyst and method for the catalytic reduction of nitrogen oxides

(76) Inventor: Tadao Nakatsuji, Espoo (FI)

Correspondence Address: YOUNG & THOMPSON, 745 SOUTH 23RD STREET 2ND FLOOR, ARLINGTON, VA, 22202

(21) Appl. No.: 10/477,179

(22) PCT Filed: May 8, 2002
(86) PCT No.: PCT/FI02/00398

(30) Foreign Application Priority Data
May 9, 2001 (FI) 20010973

(51) Int. Cl. B01D 53/56

(52) U.S. Cl. 502/302; 423/239.1

(57) ABSTRACT

The invention provides a method for catalytic decomposition of nitrogen oxides using periodic rich/lean excursions with a high durability even in the presence of oxygen, sulfur oxides and water and at high reaction temperatures and contacting the resulting exhaust gases with a double-layered catalyst, which is composed of an outer catalyst layer for reducing nitrogen oxides and an inner catalyst layer for the removal of CO, hydrocarbons and nitrogen oxides during rich/lean excursions. The outer catalyst layer contains a first compound, selected from cerium oxide, praseodymium oxide and mixtures of oxides selected from cerium oxide, zirconium oxide, praseodymium oxide, neodymium oxide, gadolinium oxide and lanthanum oxide, and the inner catalyst layer contains a second compound selected from rhodium, platinum, palladium, rhodium oxide, platinum oxide, palladium oxide and mixtures thereof, and a support.

### FIELD OF THE INVENTION

This invention relates to a method for the catalytic reduction of nitrogen oxides. More particularly, the invention relates to a method for the catalytic decomposition of nitrogen oxides (NOx) in exhaust gases by combusting with periodic rich/lean fuel supply excursions and contacting a stream of the resulting exhaust gases with a catalyst system. The method is suitable for reducing and removing harmful nitrogen oxides contained in exhaust gases e.g. from automobiles.

The invention further relates to a catalyst system for the catalytic decomposition of nitrogen oxides (NOx) in exhaust gases by combusting with periodic rich/lean fuel supply excursions and contacting a stream of the resulting exhaust gases with the catalyst system. The catalyst system is especially effective if the exhaust gases contain SOx. The catalyst system may also be composed of a support structure and said catalyst structure supported thereon or therein.

By the term “excursion” is meant a movement of the air/fuel ratio outward and back from a mean value along a time axis. By “rich” is meant an air/fuel ratio<the stoichiometric air/fuel ratio. By “lean” is meant an air/fuel ratio>the stoichiometric air/fuel ratio of the fuel in question. By the term “rich/lean fuel supply excursion” or just “rich/lean excursion” is especially menat a periodic oscillation of large air/fuel amplitude, in contrast to the sporadic variations of small air/fuel amplitude occurring e.g. during normal acceleration when driving an automibile. By “catalyst system” above is meant a working catalyst entity for said NOx removal during rich/lean combustion.

Nitrogen oxides contained in exhaust gases have been removed by, for example, a method in which the nitrogen oxides are oxidized and then absorbed in liquid alkali or a dry method in which the nitrogen oxides are reduced to nitrogen by using a reducing agent. These conventional methods have their own disadvantages. That is, the former method requires a means for handling the resulting alkaline waste liquid to prevent environmental pollution. The latter method, when it uses ammonia as a reducing agent, involves the problem that ammonia reacts with sulphur oxides in the exhaust gases to form salts, resulting in deterioration in catalytic activity. When the latter method uses hydrogen, carbon monoxide and hydrocarbons as a reducing agents in the vicinity of the stoichiometric conditions in the presence of a three-way catalyst, which comprises Pt, Rh, Pd and materials with oxygen storage capacity, the amount of the three pollutants CO, hydrocarbons and NOx is highly reduced. However, in excess oxygen conditions, the reducing agents preferentially do not react with NOx, but with oxygen. This means that substantial reduction of nitrogen oxides requires a large quantity of the reducing agent.

It was proposed to decompose nitrogen oxides catalytically in the absence of a reducing agent. However, known catalysts for direct decomposition of nitrogen oxides have not yet been put to practical use due to their low decomposing activity. On the other hand, a variety of zeolites were proposed as a catalyst for the catalytic reduction of nitrogen oxides using a hydrocarbon or an oxygen-containing organic compound as a reducing agent. In particular, Cu-ion exchanged ZSM-5 or H type (acid type) zeolite ZSM-5 (SiO₂/Al₂O₃ molar ratio=30 to 40) is regarded optimal. However, it was found that not even the H type zeolite ZSM-5 has sufficient catalytic reduction activity. In particular, the zeolite catalyst was deactivated quickly on account of dealumination of the zeolite structure when water was contained in the exhaust gas.

Under these circumstances, it has been necessary to develop a more active catalyst for the catalytic reduction of nitrogen oxides. Accordingly, a catalyst composed of an inorganic oxide carrier material having silver or silver oxide supported thereon has recently been proposed, as described in EP-A1-526 099 and EP-A1-679 427, corresponding to Japanese Patent Application Laid-open No. 5-317647. However, it has been found that the catalyst has a high activity for oxidation whereas it has a low selective reactivity to reduce nitrogen oxides, so that the catalyst has a low conversion rate of nitrogen oxides to nitrogen. In addition, the catalyst involves the problem that it is deactivated rapidly in the presence of sulphur oxides. These catalysts anyway catalyze the selective reduction of NOx with hydrocarbons under full lean conditions. However, the lower NOx conversions and narrower temperature windows compared to the three-way catalysts, which can simultaneously eliminate three toxic components: CO, NOx and hydrocarbons, make it difficult for the lean NOx catalysts to be practically used. Thus, there has been a demand for developing a more heat-resistant and active catalyst or catalytic system for the catalytic reduction of nitrogen oxides.

In order to overcome these problems, a NOx storage-reduction system has recently been proposed as one of the most promising methods, as described in Society of Automotive Engineers (SAE) Paper 950809. In the proposed system (Toyota), fuel is periodically for a short moment spiked into a combustion chamber in excess of the stoichiometric amount. Vehicles with lean burn engine can be driven at lower consumption rates than conventional vehicles even if fuel is injected in the excess. This so called NOx storage-reduction (NSR) system reduces NOx (NO+NO₂) in periodic two steps at intervals of one to two minutes. In the first step under lean conditions, NO is oxidized into NO₂ on a Pt catalyst, and the NO₂ is adsorbed on such alkali compounds as K₂CO₃ and BaCO₃. Subsequently, in the second step, the conditions are changed into rich conditions and the rich conditions are maintained for several seconds. Under the rich conditions, the adsorbed NO₂ is effectively reduced into N₂ with hydrocarbons, CO and H₂ on a Pt—Rh catalyst. This NSR system does work well for a long period in the absence of SOx. However, in the presence of SOx, the system deteriorates drastically due to the irreversible adsorption of SOx on the NO₂ adsorption sites under both lean and rich conditions.

WO 97/02886 describes a catalyst which consists of a support, on said support an NOx abatement layer containing e.g. a platinum group metal, and on said NOx abatement layer a NOx sorbent material containing e.g. an alkali metal oxide and optionally ceria. It was said that the ceria protects the alkali metal oxide from SOx and enables high NOx storage and long rich and lean excursions of about 60 seconds each. However, the effect of ceria was not described in the examples. It is well known that SOx can be more strongly adsorbed on alkali metal and/or alkaline earth oxides than ceria due to higher electric negativity of the metals. Therefore, ceria will not enhance SOx tolerance in the catalyst that consists of a NOx abatement layer containing e.g. platinum group metals, and NOx adsorbent materials containing e.g. an alkali metal oxide. In addition, in the long excursions, SOx partially reacts with ceria, oxygen storage capacity of ceria is not enough to maintain the stoichiometric conditions on the catalysts. As the results, ceria will only function as a feeble SOx adsorbent.

### SUMMARY OF THE INVENTION

It is an object of the invention to provide a method for the catalytic decomposition of nitrogen oxides (NOx) in exhaust gases by combusting with periodic rich/lean fuel supply excursions and contacting a stream of the resulting exhaust gases with a catalyst system. The method has a high durability even in the presence of oxygen, sulphur oxides and water and at high reaction temperatures. In the lean excursion, i.e., under oxidizing conditions, nitrogen oxides are selectively decomposed into nitrogen and oxygen over a reduced catalyst after a rich excursion whereby the reduced catalyst can be gradually oxidized by the formed oxygen and oxygen in exhaust gases. In the rich excursion, i.e. under reducing conditions, the oxidized catalyst is reduced, i.e., regenerated efficiently without injecting a large quantity of fuel.

The method is characterised in that the time span of one rich excursion is from about 0.5 seconds to about 10 seconds, and the time span of one lean excursion is from about 4.5 seconds to about 90 seconds, and that the used catalyst system comprises a catalyst structure having

a) an outer catalyst layer containing a first compound selected from cerium oxide, praseodymium oxide and mixtures of oxides selected from cerium oxide, zirconium oxide, praseodymium oxide, neodymium oxide, gadolinium oxide and lanthanum oxide, and

b) an inner catalyst layer containing a second compound selected from rhodium, platinum, palladium, rhodium oxide, platinum oxide, palladium oxide and mixtures thereof, and a support.

The invention further relates to a catalytic system for the catalytic decomposition of nitrogen oxides in exhaust gases by combusting with periodic rich fuel supply excursions having a time span of about 0.5 to about 10 seconds and lean fuel supply excursions having a time span of about 4.5 seconds to about 90 seconds and contacting a stream of the resulting exhaust gases with the catalyst system.

The catalyst system comprises a catalyst structure having

a) an outer catalyst layer containing a first compound selected from cerium oxide, praseodymium oxide and mixtures of oxides selected from cerium oxide, zirconium oxide, praseodymium oxide, neodymium oxide, gadolinium oxide and lanthanum oxide but lacking alkali or alkaline earth metal compounds, and

b) an inner catalyst layer containing a second compound selected from rhodium, platinum, palladium, rhodium oxide, platinum oxide, palladium oxide and mixtures thereof, and a support.

The terms “comprises”, “contains” “having” in this connection mean that the disclosed components must be present, but that further components may also be present (Grubb, Ph. W., Patents in Chemistry and Biotechnology, 1986, p. 220). The terms “first compound” and “second compound” also include mixtures and equivalents of the listed substances.

In the following, the process and the catalyst will be described in more detail. The subject matter relating to the catalyst system applies both for the claimed process and catalyst system.

### DETAILED DESCRIPTION OF THE INVENTION

Catalysts

The catalyst system comprises a layered structure, the outer layer of which is nearer to the exhaust gas and the inner layer of which is farther from the exhaust gas. Preferably, the outer catalyst layer forms the outer surface of the structure and the inner catalyst layer is inside said outer catalyst layer immediately or intermediated by an additional layer which preferably is inert.

In the outer catalyst layer, the combined amount of said first compound is preferably at least 50%, based on the combined weight of the catalyst structure. The outer catalyst layer preferably does not contain an alkali metal or alkaline earth oxide. The first compound plays a role as a buffer to maintain the reducing state of the inner catalyst layer in lean conditions, resulting in enhanced reduction rates of NOx on the inner catalyst layer, but also as a catalyst component to reduce NOx in the rich and lean excursions.

It is preferable that the components of the mixture are intimately mixed. The most preferable state of the mixture is a solid solution. In case of the binary mixture such as Ce—Zr oxides or Ce—Pr oxides, the preferable ratio of Ce/Zr or Ce/Pr is ranging from 80/20 to 60/40. In case of tri-metal mixtures such as Ce—Zr—Pr, Ce—Zr—Nd, Ce—Zr—La or Ce—Zr—Gd oxides, the preferable ratio of Ce/Zr/Pr, Ce/Zr/Nd, Ce/Zr/La or Ce/Zr/Gd is ranging from 45/30/30 to 75/20/5.

The first compound may at least be obtained by neutralizing and/or thermally hydrolyzing at least one salt of an element selected from the group consisting of cerium, praseodymium, zirconium, lanthanum, an oxide thereof, and neodymium, such as cerium nitrate (Ce(NO₃)₃.6H₂O), praseodymium nitrate (Pr(NO₃)₃.6H₂O), zirconium dinitrate oxide (ZrO(NO₃)₂.nH₂O), gadolinium nitrate (Gd(NO₃)₃.nH₂O), Lanthanum nitrate (La(NO₃)₃.6H₂O) and neodymium nitrate (Nd(NO₃)₃.6H₂O), followed by drying and calcining in air or reducing conditions. Altematively, at least one member selected from the group consisting of cerium hydroxide, praseodymium hydroxide, zirconium hydroxide, lanthanum hydroxide and neodymium hydroxide such as Ce(OH)₃, Ce(OH)₄, Pr(OH)₃, Zr(OH)₄, ZrO(OH)₂.nH₂O, La(OH)₃, Ga(OH)₃ and Nd(OH)₃ can be used directly as a precursor for thye corresponding oxide.

The inner catalyst layer contains a second compound selected from platinum and/or platinum oxide, rhodium and/or rhodium oxide, and palladium and/or palladium oxide, as well as a support. The inner catalyst layer preferably contains at least platinum and/or platinum oxide and a support.

In the inner catalyst layer, the three components CO, hydrocarbons and NOx of the exhaust gas can be eliminated under stoichiometric air/fuel conditions at high rates. The amount of said second compound is preferably 0.05-5% by weight in terms of the metal, based on the combined weight of metal and/or metal oxide and said support. Most preferably, in said inner catalyst layer, the metal(s) or its (their) compound(s) is (are) supported on an inert inorganic oxide, such as alumina, La stabilized alumina, silica, silica-alumina, titania, zirconia, or materials such as ceria and zirconium stabilized ceria and/or zeolite.

The inner catalyst layer plays an important role to enhance the velocity of changing the reaction atmosphere from lean to rich conditions and the reduction of NOx in both rich and lean excursions. According to the invention, the inner catalyst layer can be prepared by conventional methods such as wet-impregnation and ion-exchange using water soluble rhodium, platinum and palladium salts like rhodium nitrate (Rh(NO3)), tetra-ammonium platinum nitrate (Pt(NH₃)₄(NO₃)₂, and palladium nitrate (Pd(NO₃)₃).

According to the invention, there are preparation methods for producing the inner catalyst layer. A preferred method for producing the inner catalyst layer comprises supporting water-soluble salts of Rh, Pt, Pd or mixtures thereof such as a nitrate on said support, and then calcining the resultant product in an oxidative or reductive atmosphere at a temperature of 300-900° C. In the method, which e.g. is an impregnation and an ion exchange, metal and/or metal oxide of Rh, Pt, Pd or a mixture thereof is formed on the support.

The inner catalyst layer of the invention preferably contains at least Pt metal and/or oxide in an amount of 0.05-5% by weight in terms of metal based on the total of said support and said metal and/or metal oxide supported thereon. In order to enhance NOx reduction activity, Rh and/or Pd metal and/or oxide is preferably added in an amount of 0.05-1% by weight in terms of metal based on the total weight of the catalyst. When the amount of said metal, an oxide or a mixture thereof, is less than 0.05% by the said weight, the resulting catalyst has an insufficient activity in the catalytic reaction for changing the reaction atmosphere from lean to rich and in the reacting of NO with reductants present. Even if the amount is more than 5% by the said weight, the resulting inner catalyst layer has no improvement in selectivity of the catalytic reaction of NO with reductants present in the rich and lean excursions. It is in particular preferred that the inner catalyst layer contains Rh, Pt, Pd, or a mixture thereof in an amount of 0.1-3% by weight in terms of metal.

In addition, the catalyst system of the invention is excellent in resistance to sulphur oxides as well as resistance to heat. Therefore, it is e.g. suitable for use as a catalyst in the reduction of nitrogen oxides or for the denitrification of automobile exhaust gases from lean gasoline engines.

The claimed catalyst system may be obtained in various shapes such as powder or particles. Accordingly, it may be moulded into various shapes such as honeycomb, annular or spherical shapes by any of well-known methods. If desired, appropriate additives, such as moulding additives, reinforcements, inorganic fibers or organic. binders may be used when the inner catalyst layer is moulded, followed by wash coating with the outer catalyst layer.

The catalyst system of the invention may advantageously be applied, coated or deposited onto an inactive substrate of any desired shape. By way of example, a two-step wash coat method comprises an inner layer catalyst coating followed by an outer layer catalyst coating, to provide a catalyst structure, which has a layer of the catalysts on the surface of it. The coating preferably takes place by preparing slurries of the inner and outer layer catalyst components, e.g. by mixing the second and first compound with silica sol and water, and contacting the slurries in said order with the inactive substrate. The inactive substrate may be composed of, for example, a clay mineral such as cordierite or a metal such as stainless steel, preferably of heat-resistant, such as a Fe—Cr—Al steel, and may be in the form of honeycomb, annular or spherical structures.

It is especially preferred that the thickness of the inner catalyst layer is ranging from 10 to 80 μm from the surface of the substrate structure so that the resulting catalyst structure is highly active in the catalytic reduction of nitrogen oxides in the rich excursions. The depth or thickness of the inner catalyst layer is usually up to 40 μm and it depends on the activity of the inner catalyst layer. In case of a highly active inner catalyst layer, the depth can be reduced. In general, if the inner catalyst layer is more than 80 μm in thickness, the catalyst structure has no corresponding improvement in reactivity. Furthermore, it is not desirable from the standpoint of production cost to form such a thick layer of inner catalyst layer. If the inner catalyst layer has a thickness of lower than 10 μm, the resulting catalyst structure has insufficient activity in the catalytic reaction.

It is also especially preferred that the thickness of the outer catalyst layer is ranging from 20 to 80 μm from the surface of the substrate structure so that the resulting catalyst structure is highly active in the catalytic reduction of nitrogen oxides in the rich/lean excursions. The depth or thickness of the outer catalyst layer is usually up to 60 μm. In general, if the outer catalyst layer is more than 80 μm in thickness, the catalyst structure has no corresponding improvement in reactivity. Furthermore, it is not desirable from the standpoint of production cost to form such a thick layer of outer catalyst layer. If the outer catalyst layer has a thickness of lower than 20 μm, the resulting catalyst structure has insufficient activity in the NOx reduction using rich/lean excursions, because NO is oxidized into NO₂ on the inner layer catalyst in the lean operation.

In turn, the inner catalyst layer may be molded, coated or shaped into a catalyst structure of, for example, a structure having a honeycomb, annular or spherical form. By way of example, a mixture of powder inner catalyst layer material and an organic binder is prepared, kneaded and formed into a honeycomb structure. The honeycomb structure is then dried and calcined. These catalyst structures in the form of honeycomb prepared as mentioned above contain the inner catalyst layer component. After the preparation, the outer layer catalyst is additionally coated on the honeycomb-shaped inner catalyst layer. Accordingly, it is preferred that the honeycomb structure has walls of not less than 40 μm thick so that the catalyst is contained in a layer of not less than 20 μm in depth from either surface of the walls of the catalyst structure.

The catalytic system of the invention is preferably used in the catalytic reaction with an oscillation between the rich and lean conditions, periodically at 5-120 seconds, preferably 1-100 seconds intervals. The time spans of the rich and lean excursion is 0.5-10 seconds and 4.5-90 seconds, respectively. The short rich excursions enable the storage of oxygen by oxygen storage components such as ceria without interference by SOx. Thus, by combining the use of outer layer oxygen storage component and short rich excursions, a synergic oxygen storage effect has been accomplished. The rich conditions are normally prepared by periodically injecting fuel into a combustion chamber of the engine at an air/fuel by weight ratio of 10-14 in case of using gasoline as a fuel. The typical exhaust gases in rich conditions contain several hundred vol. ppm of NOx, 2-10% of water, 1-5% of CO, 1-5% of hydrogen, several thousands ppm of hydrocarbons and 0-0.5% of oxygen.

During the lean conditions, the air/gasoline fuel weight ratio is preferably regulated from about 20 to about 40. The typical exhaust gases in lean conditions are composed of several hundred ppm of NOx, 2-10% of water, several thousands ppm of CO and several thousands ppm of hydrogen, several thousands ppm of hydrocarbons and 1-15% of oxygen. A suitable temperature for the catalyst system of the invention to have effective activity in the decomposition of NOx for a long time in the rich excursion is usually in the range of 200-500° C., preferably in the range of 250-450° C., though depending on the individual gas compositions used. The process and catalyst system is especially suitable for removing NOx from hot exhaust gases coming from lean-burn gasoline and direct injection engines. Within the above recited temperature range, exhaust gases are preferably treated at a space velocity of 10,000-100,000 hr⁻¹ on the double or more layered catalyst of the claimed catalyst system

The invention also relates to the use of the above described catalyst system for the catralytic decomposition of nitrogen oxides in exhaust gases by combusting with rich/lean fuel supply excursions. The catalyst system is especially suited for removing NOx from hot exhaust gases, coming from lean-burn gasoline engines and direct injection engines. The temperature is preferably 200-500° C.

According to the method, as above described, the exhaust gas that contains nitrogen oxides is contacted with the above-described catalyst system in periodic rich/lean excursions. As a result, the method makes it possible to catalytically decompose nitrogen oxides during rich/lean excursions into nitrogen and oxygen in the exhaust gas in a stable and efficient manner even in the presence of oxygen, sulfur oxides or moisture.

The invention is now illustrated in greater detail with reference to examples; however, it should be understood that the invention is not deemed to be limited thereto. All the parts, percentages, and ratios are by weight unless otherwise indicated.

### (1) Preparation of the Catalyst

### Preparation of Powder Catalyst

(i) Inner Layer Catalyst

### EXAMPLE 1

In 100 ml of ion-exchanged water was dissolved 8.40 g of tetra-ammonium platinum nitrate (Pt(NH₃)₄(NO₃)₂ solution (9.0 wt % as Pt). Sixty grams of γ-alumina powder (KC-501 available from Sumitomo Kagaku Kogyo K. K.) was added to the aqueous solution, followed by drying at 100° C. with agitation and calcining at 500° C. for 3 hours to provide a powder catalyst. A powder catalyst supporting Pt metal/oxides on γ-alumina in an amount of 1.0 wt %, by weight in terms of platinum based on the catalyst weight was prepared.

### EXAMPLE 2

In 100 ml of ion-exchanged water was dissolved 8.40 g of tetra-ammonium platinum nitrate (Pt(NH₃)₄(NO₃)₂ solution (9.0 wt % as Pt). 45 g of γ-alumina powder (KC-501 available from Sumitomo Kagaku Kogyo K. K.) and 15 g of ceria powder (ceria HSA10 from Rhodia) was added to the aqueous solution, followed by drying at 100° C. with agitation and cacining at 500° C. for 3 hours to provide a powder catalyst. A powder catalyst supporting Pt metal/oxides on γ-alumina/ceria in an amount of 1.0 wt % by weight in terms of platinum based on the catalyst weight was prepared.

### EXAMPLE 3

In 100 ml of ion-exchanged water, 8.40 g of rhodium nitrate solution (9.0 wt % as Rh) and 4.20 g of tetra-ammonium platinum nitrate (9.0 wt % as Pt) were dissolved. Sixty grams of a La-alumina powder (available from Sumitomo Kagaku Kogyo K. K.) was added to the aqueous solution, followed by drying at 100° C. with agitation and calcining at 500° C. for 3 hours to provide a powder catalyst. The La-alumina powder catalyst contained 1.0 wt % Pt and 0.5 wt % Rh by weight in terms of metal based on the catalyst weight.

### EXAMPLE 4

In 100 ml of ion-exchanged water, 16.80 g of palladium nitrate solution (9.0 wt % as Pd) and 8.40 g of tetra-ammonium platinum nitrate (9.0 wt % as Pt) were dissolved.

Sixty grams of a silica-alumina powder (SIRAL 1 available from CONDEA Chemie GmbH) was added to the aqueous solution, followed by drying at 100° C. with agitation and calcining at 500° C. for 3 hours to provide a powder catalyst. A powder catalyst supported Pd and Pt metal/oxides on silica-alumina in an amount of 2.0 wt % Pd and 1.0 wt % Pt by weight in terms of metal based on the catalyst weight was prepared.

(ii) Outer Layer Catalyst

### EXAMPLE 5

In 1000 ml of ion-exchanged water was dissolved 151.37 g of cerium nitrate (Ce(NO₃)₃.6H₂O). 0.1N ammonium hydroxide solution was added into the cerium nitrate solution to precipitate cerium hydroxide from the cerium nitrate. After the addition, the slurry was aged for one hour. The cerium hydroxide was collected by filtration and thoroughly washed with ion-exchanged water, thereby providing a cerium hydroxide powder. 66.0 g of cerium hydroxide was dried at 120° C. for 24 hours. The dried cerium hydroxide was heated and calcined at 500° C. for three hours in air, thereby providing a ceria powder with a specific surface area of 138 m²/g.

### EXAMPLE 6

60.0 g of cerium/praseodymium oxides (60 wt %/40 wt %) (available from Rhodia) was dried at 120° C. for 24 hours. The dried oxide was heated and calcined at 500° C. for one hour in air, thereby providing ceria/praseodymium oxide powder with a specific surface area of 112 m²/g.

### EXAMPLE 7

60 g of cerium/zirconium/lanthanum oxides (22 wt %/73 wt %/5 wt % as CeO₂/ZrO₂/La₂O₃) (available from Rhodia) was dried at 120° C. for 24 hours. The cerium/zirconium/praseodymium oxides were heated and calcined at 500° C. for one hour in air, thereby providing ceria/zirconia/praseodymium oxides powder with a specific surface area of 80 m²/g.

### EXAMPLE 8

60 g of cerium/zirconium/gadolinium oxides (72 wt %/24 wt %/4 wt % as CeO₂/ZrO₂/Ga₂O₃) (available from Rhodia) was dried at 120° C. for 24 hours. The cerium/zirconium/gadolinium oxides were heated and calcined at 500° C. for one hour in air, thereby providing ceria/zirconia/praseodymium oxides powder with a specific surface area of 198 m²/g.

### EXAMPLE 9

60 g of cerium oxide/zirconium/praseodymium oxides (47 wt %/33 wt %/22 wt % as CeO₂/ZrO₂/Pr₆O₁₁) (available from Rhodia) was dried at 120° C. for 24 hours. The zirconium/cerium/praseodymium oxides were heated and calcined at 500° C. for one hour in air, thereby providing ceria/praseodymium oxide powder with a specific surface area of 205 m²/g.

### EXAMPLE 10

60 g of cerium/zirconium/neodymium oxides (70 wt %/20 wt %/10 wt % as CeO₂/ZrO₂/Nd₂O₃) (available from Rhodia) was dried at 120° C. for 24 hours. The cerium/zirconium/neodymium oxides were heated and calcined at 500° C. for one hour in air, thereby providing ceria/praseodymium oxide powder with a specific surface area of 171 m²/g.

(iii) Honeycomb Catalyst

The thickness of the catalyst layer was calculated with the assumption that the density of the layer is 1 g/cm³ and geometric specific surface area of the honeycomb is 2500 m²/m³.

### EXAMPLE 11

60 g of the powder catalyst supporting Pt metal/oxides on γ-alumina in an amount of 1.0 wt %, by weight in terms of platinum based on the catalyst prepared in Example 1, were mixed with 6 g of silica sol (Snowtex N available from Nissan Kagaku) and an appropriate amount of water. The mixture was ground with a planetary mill for five minutes using 100 g of zirconia balls as grinding media to prepare a first wash coating slurry. A cordierite honeycomb substrate, which has a cell number of 400 per square inch (400 c/p.c.i), was used for wash coating. The substrate was coated with the slurry to provide a honeycomb catalyst structure coated by the inner layer catalyst in an amount of 1 wt % Pt/γ-alumina having a thickness of 30 μm. Furthermore, sixty grams of the ceria powder catalyst, which was prepared according to Example 5, were mixed with 6 g of silica sol (Snowtex N available from Nissan Kagaku) and an appropriate amount of water. The mixture was ground with a planetary mill for five minutes using 100 g of zirconia balls as grinding media to prepare a second wash coating slurry. The honeycomb, which was coated with the powder catalyst supporting Pt metal/oxides on γ-alumina, was then additionally coated with said second slurry to provide a honeycomb catalyst structure having a ceria layer with a thickness of 60 μm coated on the 1% Pt/γ-alumina layer. This catalyst is designated as Catalyst 1.

### EXAMPLE 12

Following the procedure of Example 11, a honeycomb catalyst was prepared using the catalyst powders of Examples 1 and 6. The catalyst has on a γ-alumina catalyst support an inner layer catalyst of Pt metal/oxides with a thickness of 30 μm and an outer catalyst of cerium oxide/praseodymium oxide (60 wt %/40 wt %) with a thickness of 60 μm. This catalyst is designated as Catalyst 2.

### EXAMPLE 13

Following the procedure of Example 11, a honeycomb catalyst was prepared using the catalyst powders of Examples 3 and 6. The catalyst has on La-alumina catalyst an inner catalyst layer of Rh and Pt metal/oxides with a thickness of 30 μm and thereupon an outer catalyst layer of ceria/praseodymium oxide (60 wt %/40 wt %) with a thickness of 60 μm. This catalyst is designated as Catalyst 3.

### EXAMPLE 14

60 g of the powder catalyst composed of 1.0 wt % Pt supported on γ-alumina/ceria, which was prepared according to Example 2, were mixed with 6 g of silica sol (Snowtex N available from Nissan Kagaku) and an appropriate amount of water. The mixture was ground with a planetary mill for five minutes using 100 g of zirconia balls as grinding media to prepare a first wash coat slurry. A cordierite honeycomb substrate (400 c.p.s.i) was coated with the slurry to provide a honeycomb catalyst structure of a supported inner catalyst layer having a thickness of 30 μm. Furthermore, 60 g of the ceria/praseodymium oxide (60 wt %/40 wt %) powder catalyst of Example 6, were mixed with 6 g of silica sol (Snowtex N available from Nissan Kagaku) and an appropriate amount of water. The mixture was ground with a planetary mill for five minutes using 100 g of zirconia balls as grinding media to prepare a second wash coat slurry. The honeycomb, which was coated with the 1.0% Pt supported on γ-alumina/ceria, was additionally coated with the second slurry to provide a honeycomb catalyst structure additionally coated by a ceria catalyst layer having a thickness of 60 μm. This catalyst is designated as Catalyst 4.

### EXAMPLE 15

60 g of the powder catalyst composed of 2 wt % Pd-1 wt % Pt metal/oxides on silica-alumina of Example 4, were mixed with 6 g of the silica sol and an appropriate amount of water. The mixture was ground with a planetary mill for five minutes using 100 g of zirconia balls as grinding media to prepare a first wash coat slurry. A honeycomb substrate of cordierite (400 c.p.s.i.) was coated with the slurry to provide a honeycomb catalyst structure having a supported inner catalyst layer with the thickness of 30 μm. Furthermore, 60 g of the ceria/zirconium/lanthanum oxides (22/73/5) powder catalyst of Example 7 were mixed with 6 g of silica sol (Snowtex N available from Nissan Kagaku) and an appropriate amount of water. The mixture was ground with a planetary mill for five minutes using 100 g of zirconia balls as grinding media to prepare a second wash coat slurry. The honeycomb, which was coated with the 2 wt % Pd-1 wt % Pt supported on silica-alumina, was additionally coated with the second slurry to provide a honeycomb catalyst structure additionally being coated o with ceria/zirconium/lanthanum oxide (22/73/5) having a thickness of 60 μm. This catalyst is designated as Catalyst 5.

### EXAMPLE 16

60 g of the powder catalyst supporting 0.5% Rh and 1% Pt metal/oxides on La-alumina, which was prepared in Example 3, were mixed with 6 g of silica sol (Snowtex N available from Nissan Kagaku) and an appropriate amount of water. Following the procedure of Example 11, a honeycomb substrate (400 c.p.s.i.) was contacted with the slurry of the inner layer catalyst giving a thickness of 30 μm. Furthermore, 60 g of zirconia/ceria/gadolinium oxide (72/24/4), which was prepared in Example 8, were mixed with 6 g of silica sol (Snowtex N available from Nissan Kagaku Kogyo K. K.) and an appropriate amount of water. Following the procedure of Example 11, the honeycomb having a 30 μm layer of on the 0.5% Rh/1% Pt/La-alumina was additionally contacted with the slurry of the outer layer catalyst to provide a honeycomb catalyst structure having the catalyst additionally coated with a zirconia/ceria gadolinium oxide (72/24/4) with the thickness of 60 μm. This catalyst is designated as Catalyst 6.

### EXAMPLE 17

Following the procedure of Example 16, a honeycomb catalyst structure coating the 0.5% Rh/1% Pt/La-alumina catalyst with the thickness of 30 μm was provided. Furthermore, zirconium/cerium/praseodymium oxides (47/33/22), which was prepared in Example 9, was additionally coated on the honeycomb coating the 0.5% Rh/1% Pt/La-alumina catalyst with the thickness of 60 μm in the same way as in Example 11. This catalyst is designated as Catalyst 7.

### EXAMPLE 18

Following the procedure of Example 16, a honeycomb catalyst structure coating the 0.5% Rh/1% Pt/La-alumina catalyst with the thickness of 30 μm was prepared. Furthermore, a zirconium/cerium/neodymium oxides (70/20/10) powder catalyst, which was prepared in Example 10, was additionally coated on the honeycomb coating the 0.5% Rh/1% Pt/La-alumina catalyst with the thickness of 60 μm in the same way as in Example 11. This catalyst is designated as Catalyst 8.

### EXAMPLE 19

Following the procedure of Example 16, a honeycomb catalyst coating the 0.5% Rh/1% Pt/La-alumina catalyst with the thickness of 20 μm was prepared. Furthermore, a zirconium/cerium/praseodymium oxides (47/33/22) powder catalyst, which was prepared in Example 9, was additionally coated on the 0.5% Rh/1% Pt/γ-alumina coated honeycomb with a thickness of 60 μm in the same way as in Example 11. This catalyst is designated as Catalyst 9.

### EXAMPLE 20

Following the procedure of Example 16, a honeycomb coated by a 0.5% Rh/1% Pt/La-alumina catalyst with the thickness of 30 μm was prepared. Furthermore, high surface area-ceria powder catalyst (Ceria HSA5 available from Rhodia) having 250 m²/g of specific surface area, was additionally coated on the honeycomb coating the 0.5% Rh/1% Pt/γ-alumina catalyst with the thickness of 60 μm in the same way as in Example 11. This catalyst is designated as Catalyst 10.

### EXAMPLE 21

Following the procedure of Example 12, a honeycomb coated by a 0.5% Rh/1% Pt/La-alumina catalyst having a thickness of 20 μm was prepared. In the same way as in Example 11, the honeycomb catalyst structure was coated with the cerium oxide/praseodymium oxide (60 wt %/40 wt %) of Example 6 giving an outer layer thickness of 80 μm. This catalyst is designated as Catalyst 11.

### EXAMPLE 22

Following the procedure of Example 12, a honeycomb coated by a 0.5% Rh/1% Pt/La-alumina inner catalyst layer with a thickness of 15 μm was prepared. In the same way as in Example 11, the coated honeycomb structure was further coated with the cerium oxide/praseodymium oxide (60 wt %/40 wt %) of Example 6 having a thickness of 30 μm. This catalyst is designated as Catalyst 12.

### EXAMPLE 23 (COMPARATIVE)

Following the procedure of Example 11, a honeycomb coated by a 0.5% Rh/1% Pt/La-alumina catalyst layer having a thickness of 30 μm was prepared. In the same way as in Example 11, such a honeycomb catalyst structure coated by the cerium/praseodymium oxide (60 wt %/40 wt %) powder of Example 6, with the thickness of 20 μm, was prepared. This catalyst is designated as Catalyst 13.

### EXAMPLE 24 (COMPARATIVE)

40 g of the powder catalyst supporting Pt metal/oxides on γ-alumina in an amount of 1.0 wt %, which was prepared in Example 1, and 20 g of the cerium oxide/praseodymium oxide (60 wt %/40 wt %) powder, which was prepared in Example 6, were mixed. The mixture was further mixed with 6 g of silica sol (Snowtex N available from Nissan Kagaku) and an appropriate amount of water. The mixture was ground with a planetary mill for five minutes using 100 g of zirconia balls as grinding media to prepare a wash coat slurry. A cordierite honeycomb substrate (400 c.p.s.i.) was used for wash coating by the catalyst. The substrate was coated with the slurry to provide a honeycomb catalyst structure coated with 1 wt % Pt/γ-alumina/cerium oxide/praseodymium oxide (60 wt %/40 wt %) having a thickness of 80 μm. This catalyst is designated as Catalyst 14.

### EXAMPLE 25 (COMPARATIVE)

40 g of the powder catalyst supporting Pt/Rh metal/oxides on La-alumina in an amount of 1.0/0.5 wt %, which was prepared in Example 3, and 20 g of BaCO₃ powder prepared by wet precpitation process (specific surface area: 2 m²/g) and 5 g of K₂CO₃ were mixed. The mixture was mixed with 6 g of silica sol (Snowrex N available from Nissan Kagaku) and an appropriate amount of water. The mixture was ground with a planetary mill for five minutes using 100 g of zirconia balls as grinding media to prepare a wash-coat slurry. A cordierite honeycomb substrate (400 c.p.s.i.) was used for wash-coating of catalyst. The substrate was coated with the slurry to provide a honeycomb catalyst structure coating 1/0.5 wt % Pt/Rh supported on BaCO₃—K₂CO₃—La-alumina with the thickness of 80 μm. This catalyst is designated as Catalyst 15.

### (2) Performance Tests

Using the catalysts (1 to 11 and 12) and the comparative catalysts (13 and 14), a nitrogen oxide containing gas was reduced under the conditions below. The conversion of nitrogen oxides to nitrogen was determined by a chemical luminescence method. Furthermore, using the catalysts (7 and 15), durability tests in the presence of SOx were conducted at 350° C. for 50 h in the same conditions as the catalyst examination. The results are shown in Table 2.

Test Methods:

The mixture for the NOx reduction experiment under rich conditions comprised of 200 ppm of NO, 20 ppm of SO₂, 0.4% of O₂, 2% of CO, 2000 ppm of C₃H₆, 9.0% of H₂O and 2% of H₂. The gas composition under lean conditions was composed of 182 ppm of NO, 18.5 ppm of SO₂, 9.2% of O₂, 0.1% of CO, 100 ppm of C₃H₆, 8.2% of H₂O and 0.1% of H₂ and it was prepared by injecting oxygen into the mixture under rich conditions. The catalyst was examined in the catalytic reaction with an oscillation between the rich and lean conditions, periodically at 10-120 seconds intervals (perturbed scan) and 1/10 of the ratio of rich/lean time spans, as shown with an example in FIG. 1.

(i) Space Velocity:. 100,000 hr⁻¹ (under lean conditions); 99,017 hr⁻¹ (under rich conditions).

(iii) Reaction Temperature:

250, 300, 350, 400, 450 or 500° C.

The results are shown in the Table.

As is apparent from the Table, the catalysts of the invention achieve high conversion of nitrogen oxides, whereas the comparative catalysts have on the whole a low conversion rate of nitrogen oxides. In addition, the catalysts of the invention are durable even when they are used at high temperatures and show excellent resistance to sulphur oxides.

TABLE 1

| | Rich/lean | | | | | | |
|---|---|---|---|---|---|---|---|
| | spans | Temperature (° C.) | | | | | |
| Catalyst | (sec.) | 250 | 300 | 350 | 400 | 450 | 500 |
| Catalyst 1 | 6/60 | 88.3 | 94.8 | 91.3 | 87.2 | 74.5 | 59.1 |
| Catalyst 2 | 3/30 | 98.3 | 99.0 | 99.4 | 98.4 | 92.4 | 77.1 |
| | 6/60 | 96.6 | 98.6 | 98.2 | 95.8 | 89.7 | 70.6 |
| | 12/120 | 88.8 | 90.2 | 90.9 | 88.7 | 81.3 | 63.2 |
| Catalyst 3 | 6/60 | 96.5 | 98.5 | 98.4 | 96.5 | 90.5 | 72.4 |
| Catalyst 4 | 6/60 | 97.4 | 98.9 | 97.8 | 93.7 | 83.9 | 69.3 |
| Catalyst 5 | 6/60 | 91.2 | 94.1 | 95.4 | 93.9 | 87.7 | 68.5 |
| Catalyst 6 | 6/60 | 94.3 | 98.2 | 96.7 | 94.6 | 89.2 | 70.7 |
| Catalyst 7 | 6/60 | 97.6 | 99.7 | 96.6 | 92.5 | 86.2 | 67.4 |
| Catalyst 8 | 6/60 | 98.4 | 99.4 | 98.3 | 90.8 | 85.1 | 64.6 |
| Catalyst 9 | 6/60 | 95.1 | 97.0 | 94.2 | 91.4 | 86.1 | 66.7 |
| Catalyst 10 | 6/60 | 90.6 | 95.1 | 93.0 | 88.3 | 73.0 | 60.2 |
| Catalyst 11 | 6/60 | 97.9 | 99.3 | 96.8 | 93.4 | 90.1 | 75.7 |
| Catalyst 12 | 6/60 | 93.2 | 95.8 | 92.5 | 88.0 | 79.3 | 58.9 |
| Catalyst 13 | 6/60 | 84.7 | 86.3 | 85.0 | 79.5 | 66.8 | 43.6 |
| Catalyst 14 | 6/60 | 42.8 | 25.0 | 13.4 | 8.5 | 4.4 | 2.9 |
| Catalyst 15 | 6/60 | 87.0 | 98.4 | 99.3 | 99.6 | 93.6 | 85.7 |

TABLE 2

| Running hour | 0 | 10 | 20 | 30 | 40 | 50 |
|---|---|---|---|---|---|---|
| Catalyst 15 | 99.3 | 50.8 | 33.4 | 19.6 | 8.5 | 5.0 |
| Catalyst 7 | 99.7 | 99.5 | 99.3 | 98.6 | 97.9 | 98.1 |

1-26. (canceled)

27. A method for the catalytic decomposition of nitrogen oxides (NOx) in exhaust gases by combusting with periodic rich/lean fuel supply excursions and contacting a stream of the resulting exhaust gases with a catalyst system, wherein a time span of one rich excursion is from about 0.5 seconds to about 10 seconds, and the time span of one lean excursion is from about 4.5 seconds to about 90 seconds, and that the catalyst system comprises a catalyst structure having:
a) an outer catalyst layer containing at least 50% by weight a first compound, selected from cerium oxide, praseodymium oxide and mixtures of oxides selected from cerium oxide, zirconium oxide, praseodymium oxide, neodymium oxide, gadolinium oxide and lanthanum oxide, and
b) an inner catalyst layer containing a second compound selected from rhodium, platinum, palladium, rhodium oxide, platinum oxide, palladium oxide and mixtures thereof, and a support.

28. The method according to claim 27, wherein the catalyst system is a two layer structure, the outer catalyst layer forming the outer surface of the structure and the inner catalyst layer being immediately inside said outer catalyst layer.

29. The method according to claim 27, wherein, in the inner catalyst layer, the amount of said second compound is 0.05-5% by weight in terms of rhodium, platinum or palladium, the rest being an essentially inert material.

30. The method according to claim 27, wherein one period of said rich and lean excursion lasts from about 5 to about 120 seconds.

31. The method according to claim 27, wherein the time span of one rich excursion is from about 0.5 seconds to about 10 seconds.

32. The method according to claim 27, wherein the time span of one lean excursion is from about 4.5 seconds to about 90 seconds.

33. The method according to claim 27, wherein during the rich excursions, the air/gasoline fuel weight ratio is regulated to from about 10 to about 14, so that the resulting exhaust gases contain several hundred volume ppm of nitrogen oxides, 2 to 10 volume % of water, 1 to 5 volume % of carbon monoxide, 1 to 5% of hydrogen, several thousands volume ppm of hydrocarbons and 0 to 0.5% of oxygen.

34. The method as claimed in claim 27, wherein the resulting exhaust gases are contacted with the outer and inner catalyst layers at a temperature of about 200° C. to about 500° C.

35. A catalyst system for the catalytic decomposition of nitrogen oxides (NOx) in exhaust gases by combusting with periodic rich fuel supply excursions having a time span of about 0.5 to about 10 seconds and lean fuel supply excursions having a time span of about 4.5 to about 90 seconds and contacting a stream of the resulting exhaust gases with the catalyst system, the catalyst system comprising a catalyst structure having:
a) an outer catalyst layer containing at least 50% by weight of a first compound selected from cerium oxide, praseodymium oxide and mixtures of oxides selected from cerium oxide, zirconium oxide, praseodymium oxide, neodymium oxide, gadolinium oxide and lanthanum oxide but lacking alkali or alkaline earth metal compounds, and
b) an inner catalyst layer containing a second compound selected from rhodium, platinum, palladium, rhodium oxide, platinum oxide, palladium oxide and mixtures thereof, and a support.

36. The catalyst system according to claim 35, wherein the catalyst system is a two layer structure, the outer catalyst layer forming the outer surface of the structure and the inner catalyst layer being arranged immediately inside said outer catalyst layer.

37. The catalyst system according to claim 9, wherein, in the inner catalyst layer, the amount of the second compound is 0.05-5% by weight in terms of rhodium, platinum or palladium, based on the total weight of the inner catalyst layer, the rest being an essentially inert material.

38. The method according to claim 27, wherein one period of said rich and lean excursion lasts from about 10 to about 100 seconds.

39. The method as claimed in claim 27, wherein the resulting exhaust gases are contacted with the outer and inner catalyst layers at a temperature of about 250° C. to about 450° C.
